(19) United States
(12) Patent Application Publication
(10) Pub. No.: US 2002/0013630 A1
(43) Pub. Date: Jan. 31, 2002

(54) Program-controlled unit

(76) Inventor: Christian Siemers, Hildesheim (DE)

Correspondence Address: LERNER AND GREENBERG, P.A., POST OFFICE BOX 2480, HOLLYWOOD, FL, 33022-2480, US

(21) Appl. No.: 09/816,933

(22) Filed: Mar. 23, 2001

Related U.S. Application Data
(63) Continuation of application No. PCT/DE99/01988, filed on Jul. 1, 1999.

(30) Foreign Application Priority Data
Sep. 23, 1998 (DE) 198 43 637.8

(51) Int. Cl. G05B 11/01; G05B 19/42

(52) U.S. Cl. 700/18; 700/86

(57) ABSTRACT

A self testable communications device (102) such as a cable modem, a system (100) of remotely distributed such devices (102) and the method (140) of testing. One or more cable modems (102) are connected to a distribution hub (110). Each cable modem (102) includes a connection test initiator, such as a button (130) on the cable modem (102), on a web page or, on a computer (104) desk top which is accessible from the particular cable modem (102). When a test (140) is initiated by pressing or selecting the button (130), the system (100) initiates diagnostics (140) to check the connection of the cable modem (102) to the distribution hub (110). After the test (140) is complete, the cable modem user is provided with an automatic response indicating connection test (140) results.

### CROSS-REFERENCE TO RELATED APPLICATION

This application is a continuation of copending International Application No. PCT/DE99/01988, filed Jul. 1, 1999, which designated the United States.

### BACKGROUND OF THE INVENTION

Field of the Invention

The invention lies in the computer technology field and pertains, more specifically, to a program-controlled unit with one or more application-specifically configurable, intelligent interfaces.

Program-controlled units are devices controlled by software programs, that is to say microprocessors, microcontrollers or the like. They exist in a multiplicity of diverse embodiments and need not be described in specific detail.

Even though microprocessors, microcontrollers and the like can be obtained in a wide variety of embodiments (or perhaps precisely because of this), it is difficult or sometimes even impossible to find one type which can satisfy the requirements imposed in the specific individual case (and as far as possible only these requirements).

This is particularly applicable to microcontrollers because after all, if possible, all the peripherals (analog/digital converter, digital/analog converter, timer, interrupt controller, etc.) required for the relevant application are intended to be integrated in the microcontrollers.

If the microcontroller selected for the relevant application is one which—for whatever reason—cannot satisfy all of the requirements imposed, then this generally means that the hardware within which the microcontroller is intended to be used becomes more complex. This turns out to be particularly difficult and complex in the case of microcontrollers because the latter are not designed to cooperate with coprocessors and the like.

On the other hand, if the microcontroller selected for the relevant application is one which can do more than is required, then the price of the product containing the microcontroller generally rises as a result. Added to this is the fact that often the operation of the microcontroller also becomes more complex and more complicated. This is because the unrequited peripheral units of the microcontroller also have to be taken into account during the system development and be controlled as intended by the intelligent core of the microcontroller (the so-called microprocessor core or μP core) which processes the instructions to be executed.

### SUMMARY OF THE INVENTION

It is accordingly an object of the invention to provide a program-controlled unit, which overcomes the above-mentioned disadvantages of the heretofore-known devices and methods of this general type and which provides for a program-controlled unit that can be used optimally in each case for a large number of highly varied applications.

With the foregoing and other objects in view there is provided, in accordance with the invention, a program-controlled unit with one or more application-specifically configurable intelligent interfaces, comprising:

an intelligent core configured to process instructions to be executed;

a plurality of units selected from the group consisting of internal peripheral units disposed inside the program-controlled unit, external peripheral units exterior to the program-controlled unit, and one or more memory devices;

a structurable hardware unit selectively forming an application-specifically configurable intelligent interface for respectively connecting the intelligent core and the units, including an interface connection between the intelligent core and the internal peripheral units, between the intelligent core and the external peripheral units, between the intelligent core and the memory devices, and between the plurality of units; and

wherein the structurable hardware unit is configured to evaluate and process data and/or signals received thereby.

Alternatively, or in addition, the structurable hardware unit is configured to inject instructions into an instruction pipeline of the intelligent core.

In another alternative, or in addition, the structurable hardware unit is configured to generate and to output interrupt requests and/or event-signaling messages.

Finally, in a further alternative, the structurable hardware unit is configured to selectively react to interrupt requests or other event-signaling messages from devices connected thereto and prevent the interrupt requests or the event-signaling messages from being forwarded.

In sum, the program-controlled unit comprises one or more application-specifically configurable intelligent interfaces.

Given appropriate configuration, such interfaces can to the greatest possible extent independently ensure that the intelligent core and one or more peripheral units and/or the intelligent core and one or more memory devices and/or two or more peripheral units themselves and/or one or more peripheral units and one or more memory devices cooperate as desired with minimal loading of the intelligent core.

In accordance with an added feature of the invention, the structurable hardware unit is disposed in circuit terms between the intelligent core and the plurality of units.

In accordance with an additional feature of the invention, the structurable hardware unit is connected to a multiplicity of potential data and signal sources and data and signal destinations, and a plurality of multiplexers are connected to the structurable hardware unit for selecting current data and signal sources and current data and signal destinations.

In accordance with another feature of the invention, the data and signal sources and the data and signal destinations comprise the intelligent core, the peripheral units, the memory devices, and/or portions of the structurable hardware unit itself.

In accordance with a further feature of the invention, the structuring of the structurable hardware unit selectively results in an alteration of given data paths and/or in a configuration of logic elements.

In accordance with again an added feature of the invention, the structurable hardware unit comprises a clock generation unit generating a clock signal and a logic block unit connected to receive the clock signal, the logic block unit enabling devices to be connected via the structurable hardware unit to cooperate as desired.

In accordance with again an additional feature of the invention, the clock generation unit and the logic block unit each contain configurable elements.

In accordance with again another feature of the invention, the clock generation unit is formed at least in part by a DNF logic configuration, a NAND array, a multiplexer-based logic variant, and/or a structurable logic configuration.

In accordance with again a further feature of the invention, the logic block unit is formed at least in part by a DNF logic configuration, a NAND array, a multiplexer-based logic variant, and/or a structurable logic configuration.

In accordance with yet an added feature of the invention, the logic block unit comprises at least one logic block subdivided at least partly into individually configurable sub-blocks with predetermined tasks. Preferably, one of the sub-blocks is configured as a processing device enabled for arithmetic and/or logical processing of data input to the sub-block. It is also possible for one of the sub-blocks to be configured as a state machine for central sequence control. Similarly, one of the sub-blocks may be configured as an address calculation device for calculating source and destination addresses. Also, it is possible for one of the sub-blocks to be configured as an instruction injection device for injecting instructions into the instruction pipeline of the intelligent core.

In accordance with yet an additional feature of the invention, the structurable hardware unit is configurable with fuses and/or anti-fuses.

In accordance with yet another feature of the invention, the structurable hardware unit is reversibly configurable. In a preferred embodiment, the structurable hardware unit is configurable based on data representing a desired configuration, and the data are stored in memory devices insertible into a memory or I/O area which is addressible by the intelligent core.

In accordance with yet a further feature of the invention, the structurable hardware unit is enabled for reconfiguration only at predetermined times.

In accordance with a concomitant feature of the invention, the structurable hardware unit is enabled for reconfiguration at any time.

If the interfaces are made in such a way that they are reconfigurable during entirely normal operation of the program-controlled unit, then the program-controlled unit can even be reconfigured dynamically.

Consequently, a program-controlled unit has been created which can be used optimally in each case for a large number of highly varied applications.

Other features which are considered as characteristic for the invention are set forth in the appended claims.

Although the invention is illustrated and described herein as embodied in a program-controlled unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic illustration of the construction of the program-controlled unit according to the invention;

FIG. 2 is a schematic illustration of the construction of an SLE layer 12 of the program-controlled unit in accordance with FIG. 1;

FIG. 3 is a schematic diagram of the construction of a clock generation unit 121 of the SLE layer 12 in accordance with FIG. 2;

FIG. 4 is a schematic diagram of the construction of a logic block unit 122 of the SLE layer 12 in accordance with FIG. 2; and

FIG. 5 is a schematic diagram illustrating the configuration of the logic block unit 122 in accordance with FIG. 4 for a practical example.

### DESCRIPTION OF THE PREFERRED EMBODIMENTS

The exemplary program-controlled unit described in more detail below is a microcontroller. It will be understood, however, that the program-controlled unit can, in principle, also be any other program-controlled unit, such as a microprocessor for example.

The microcontroller considered herein is designated by the reference symbol 1 in the figures. It is distinguished by the fact that it comprises one or more application-specifically configurable intelligent interfaces.

The novel microcontroller construction is referred to below as application-specifically structurable controller architecture or ASSC architecture.

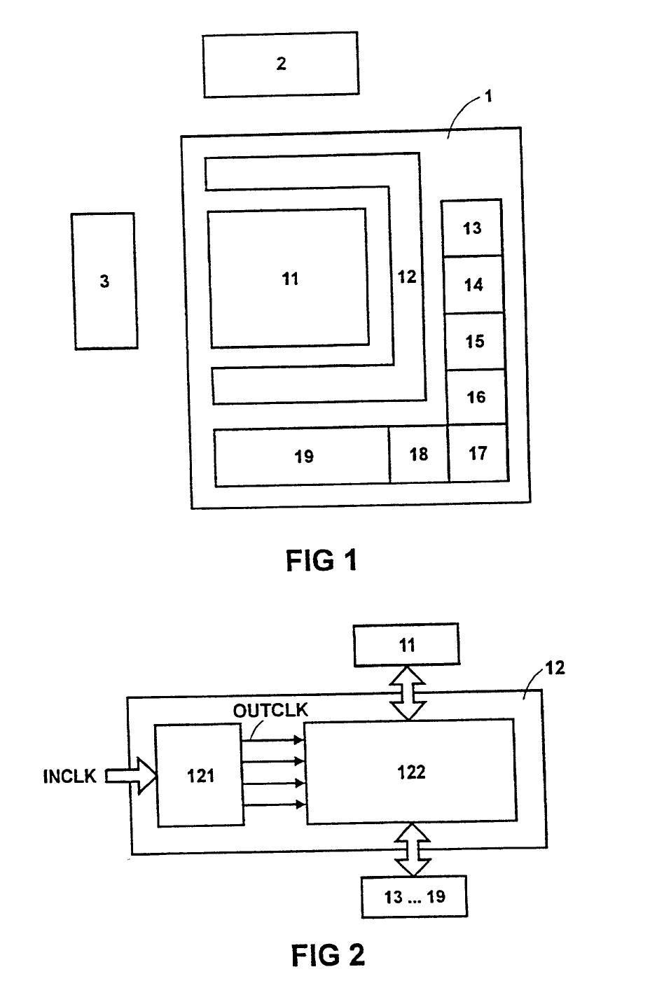

The general structure of a microcontroller having the ASSC architecture is schematically illustrated in FIG. 1.

Referring now to the figures of the drawing in detail and first, particularly, to FIG. 1 thereof, there is shown an intelligent core 11, which is usually referred to as microprocessor core or μP core and processes the instructions to be executed, a so-called SLE layer 12 and also peripheral units 13 to 19, the peripheral units, for their part, comprising a serial interface unit 13, a parallel interface unit 14, an analog/digital converter 15, a digital/analog converter 16, a timer 17, an interrupt controller 18 and, if appropriate, further peripheral units 19. Furthermore, an external random access memory (RAM) 2 and an external read-only memory (ROM) 3 are provided; the RAM 2 and the ROM 3 can also be realized as internal memories without any difficulty.

The SLE layer 12 is arranged in circuit terms between the μP core 11, peripheral units (for example the peripheral units 13 to 19) provided inside and/or outside the program-controlled unit, and/or memory devices (for example the RAM 2 and/or the ROM 3). It contains structurable data paths and/or logic elements which can be structured or configured in such a way that the SLE layer 12 can be used as the at least one application-specifically configurable interface, more precisely as a configurable intelligent interface between the μP core and one or more peripheral units and/or between the μP core and one or more memory devices and/or between two or more peripheral units themselves and/or between one or more peripheral units and one or more memory devices.

Within the SLE layer 12 there are preferably both direct connections and configurable data paths and data path linkages between the devices which are connected or can be connected via the SLE layer; the effect achieved by the direct connections is that the novel microcontroller can also be utilized like a conventional microcontroller (not having an SLE layer 12).

If the SLE layer 12 has access to memory devices (for example to the RAM 2 and/or to the ROM 3) it can transfer data from and to the memory devices independently, i.e. without the participation of the μP core, for itself and/or the μP core and/or the peripheral units. As a result, data transfers can be carried out more rapidly and without burdening the μP core 11. In this case, the SLE layer 12 is designed in such a way that it can identify and handle contending accesses to memory devices.

The SLE layer 12 can also be constructed without an interface to the memory devices present. In that case, the SLE layer and the μP core are preferably designed in such a way that the SLE layer can inject into the UP core (more precisely into the instruction pipeline thereof) instructions which can cause the μP core to carry out data transfers required by the SLE layer and/or the peripheral units.

The basic construction of the SLE layer 12 is illustrated in FIG. 2. The SLE layer 12 comprises a clock generation unit 121 and a logic block unit 122.

The clock generation unit 121 serves for supplying the logic block unit 122 with one or more different clock signals OUTCLK generated on the basis of one or more master clock signals INCLK. By way of example, clock signals having an altered frequency, altered duty ratio and/or altered phase angle relative to the master clock signal or signals INCLK are generated in the clock generation unit 121.

In the example considered, the clock generation unit 121 comprises a fast configurable logic arrangement, for example a so-called DNF logic arrangement (NOT-AND-OR logic), suitable for the practical realization of a disjunctive normal form, with downstream configurable storage, inversion/buffering and feedback. A two-stage DNF architecture (having two DNF blocks) is used in the example considered.

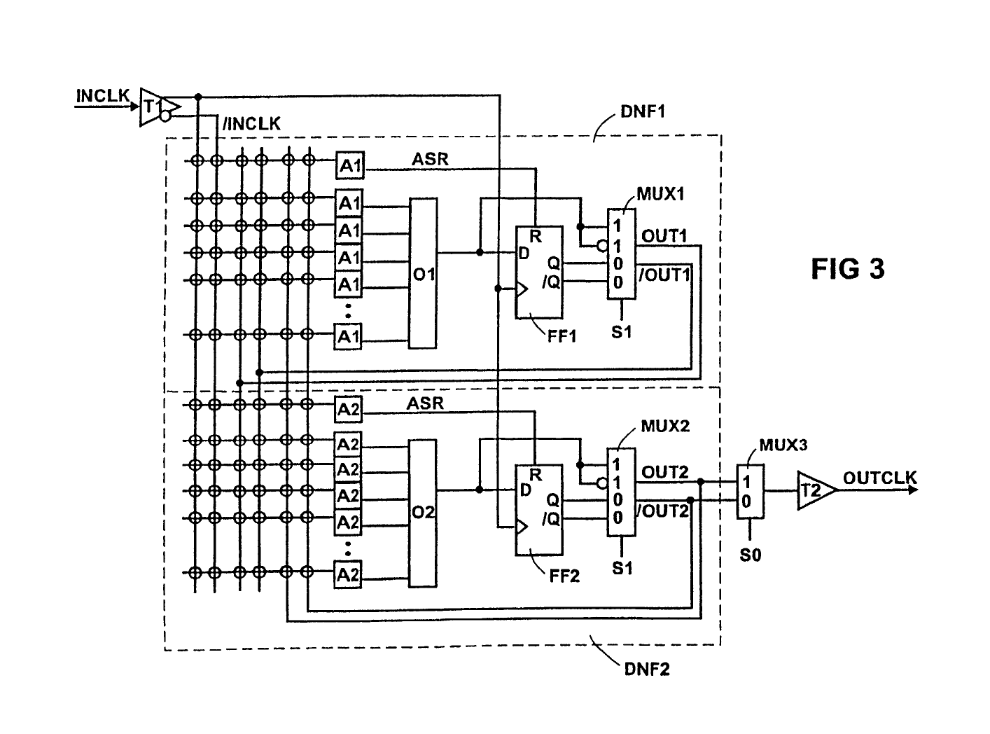

The fundamental construction of a clock generation unit 121 which generates an output clock signal OUTCLK on the basis of a master clock signal INCLK (for example the CPU clock signal) is illustrated in FIG. 3. The customary form of representation for PALs (programmable array logic) and GALs (Generic array logic) has been chosen; transparent nodes represent configurable connections, and filled-in (black) nodes represent permanent connections.

In the example considered, the clock generation unit 121 comprises two identically constructed DNF blocks DNF1 and DNF2, the first DNF block DNF1 representing a first DNF logic stage and comprising AND elements A1, an OR element O1, a flip-flop FF1 (clocked by the master clock signal), and a multiplexer MUX1, and the second DNF block DNF2 representing a second DNF logic stage and comprising AND elements A2, an OR element O2, a flip-flop FF2 (clocked by the master clock signal), and a multiplexer MUX2. The two DNF blocks DNF1 and DNF2 are supplied with the same input signals. In the example considered, the input signals comprise the master clock signal INCLK, the inverted master clock signal/INCLK, an output signal OUT1 of the first DNF block DNF1, the inverse output signal/OUT1, an output signal OUT2 of the second DNF block DNF2, and the inverse output signal/OUT2. The output signal OUT2 of the second DNF block DNF2 and the inverse output signal/OUT2 are fed to a multiplexer MUX3, and the output signal thereof is output via a driver T2 as the output clock signal OUTCLK to be generated.

The input signals, more precisely signal combinations which can be selected via configurable connections, applied to the respective DNF blocks DNF1 and DNF2 are applied to the AND elements A1 and A2 of the respective DNF blocks. The output signals of the AND elements A1 and A2 are fed to the OR elements O1 and O2, respectively, or used as a reset signal ASR for asynchronously resetting the flip-flops FF1 and FF2, respectively. The output signals of the OR elements O1 and O2 are used as input signals of the flip-flops FF1 and FF2, respectively; they (the output signals of the OR elements O1 and O2) and the inverse output signals are additionally applied to the multiplexers MUX1 and MUX2, respectively. The output signals and the inverse output signals of the flip-flops FF1 and FF2 are likewise applied as input signals to the multiplexers MUX1 and MUX2, respectively. The output signal and the inverse output signal of the multiplexers MUX1 and MUX2 are the output signals OUT1,/OUT1, OUT2 and/OUT2, already mentioned above, of the two DNF blocks of the clock generation unit 121.

Such a construction, or a similar construction, of the clock generation unit 121 allows the generation of a multiplicity of clock variations; the feedback of (internal) signals (the signals OUT1,/OUT1, OUT2,/OUT2 in the example considered) generated within the clock generation unit 121 also makes it possible to realize non-binary duty and division ratios.

The arrangement shown in FIG. 3 is only a simple example for explaining the fundamental construction of the clock generation unit 121. In practice, the number of clock signals generated by the clock generation unit 121 should not be less than four. The lower limit for the possible number of terms per DNF should likewise be four. For each generated clock signal, at least one internal signal should be generated and be provided like the internal signals OUT1,/OUT1, OUT2 and/OUT2, for example, as a possible basis for the clock signal generation.

The clock generation unit 121 need not necessarily be constructed using a two-stage DNF logic arrangement. The DNF logic arrangement used may also have fewer stages (that is to say just one stage) or arbitrarily many more stages.

Instead of the DNF logic arrangement, it is also possible to use another structurable logic arrangement, for example NAND arrays or multiplexer-based variants.

The logic block unit 122 already mentioned above is the actual core of the SLE layer 12. Like the clock generation unit 121, it may comprise a structurable logic arrangement suitable for the practical realization of the disjunctive normal form, or one of the alternatives mentioned. Virtually any desired linkages, processing and evaluations of the input signals can be carried out by means of such universally usable structurable logic arrangements. A logic block unit 122 of this type is extremely flexible.

In the example considered in the present case, the logic block unit 122 has been realized differently: it contains one or more logic blocks which are subdivided at least partly into sub-blocks with predetermined tasks. This simplifies the complexity of the gates used but hardly reduces the flexibility of the SLE layer 12—at any rate given a suitable definition of the sub-blocks and corresponding cross-connections between the individual sub-blocks.

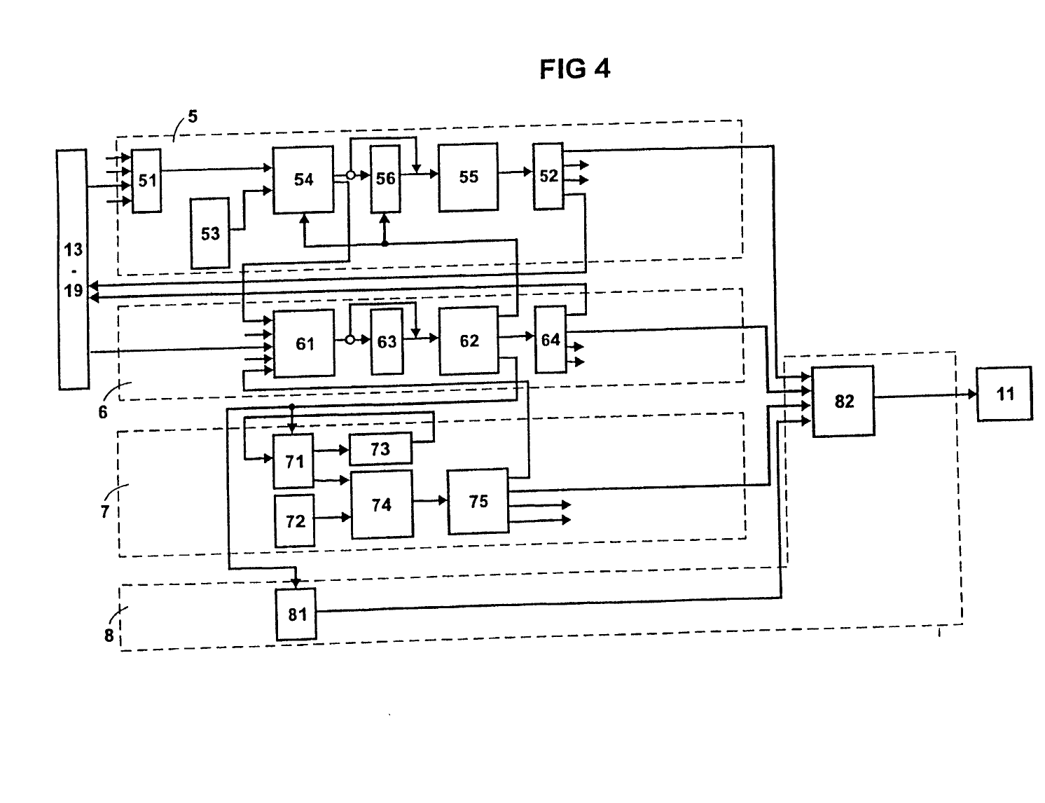

The fundamental construction of a logic block subdivided into various sub-blocks is illustrated in FIG. 4. The logic block shown therein comprises four sub-blocks, namely

a first sub-block 5 for the inputting and/or outputting of data and/or signals and the processing thereof,

a second sub-block 6 for central sequence control for the operations proceeding within the relevant logic block,

a third sub-block 7 for address calculations, and

a fourth sub-block 8 for instruction injections into the μP.

In the example considered, the sub-blocks comprise configurable multiplexers (for switching data paths as desired), registers (for buffer-storing data and/or coded states) and structurable logic (for linking data and/or signals with one another and with constants and for coding and decoding states).

In the example considered, the first sub-block 5 serves for linking input data and/or signals with one another or with constants; in the example considered, it comprises a first multiplexer 51, a second multiplexer 52, a constant register 53, a first structurable logic arrangement 54, a second structurable logic arrangement 55, and a register 56.

Data and/or signals switched through by the first multiplexer 51 are linked with one another or with constants stored in the constant register 53 by the structurable logic arrangements 54 and 55 and output via the second multiplexer 52. The register 56 provided between the structurable logic arrangements 54 and 55 serves as a buffer store which can be used, for example, for buffer-storing data that are to be linked until the other data with which they are to be linked are valid; the data and/or signals output by the structurable logic arrangement 54 can alternatively be transmitted via a bypass directly (without a detour via the register 56) to the structurable logic arrangement 55.

The multiplexers 51 (source selection) and 52 (destination selection) connect the first sub-block 5 to different data and/or signal sources and data and/or signal destinations. Data and/or signal sources and data and/or signal destinations are, in particular, the other sub-blocks, the μP core 11, peripheral units (e.g. the peripheral units 13 to 19) provided inside and/or outside the microcontroller, and/or memories (e.g. the RAM 2 and/or the ROM 3). The connection to the aforementioned or other data and/or signal sources and data and/or signal destinations can be effected via databuses (but does not have to be).

The first sub-block 5 is operatively comparable with the arithmetic logic unit (ALU) of a program-controlled unit working according to the Von Neumann Principle.

In the example considered, the second sub-block is a state machine for central sequence control in the relevant logic block; in the example considered, it comprises a first structurable logic arrangement 61, a second structurable logic arrangement 62, a register 63, and a multiplexer 64.

It is incumbent upon the structurable logic arrangement 61 to determine the respective state of the relevant logic block, in particular in a manner dependent on the states, signals and signal profiles in or from the clock generation unit 121, the other sub-blocks, the μP core 11, the peripheral units (e.g. the peripheral units 13 to 19) and/or the memories (e.g. the RAM 2 and/or the ROM 3); the operation which should (must) currently proceed in the logic block depends on the respective state of said logic block. The aforesaid state, more precisely a data value representing it, may be stored in the register 63 and be decoded as required by the structurable logic arrangement 62. The structurable logic arrangement 62 outputs one or more output signals. These output signals are control signals based on the respective state of the relevant logic block and are output via the multiplexer 64 in particular to the other sub-blocks, but also, if appropriate, to the μP core, the peripheral units and/or the memory devices.

In the example considered, the second sub-block 6 can be used to realize different simple automata types (up to Mealy), to be precise also with different clocks.

The task incumbent upon the second sub-block 6 is comparable with the control unit of a Von Neumann CPU, the processing of instructions naturally being omitted (the states are traversed in a manner triggered by external signals).

In the example considered, the third sub-block 7 serves in particular (but not exclusively) for address calculation for block-by-block data transfers; in the example considered, it comprises an address register 71, a constant register 72, an incrementing/decrementing unit 73, a first structurable logic arrangement 74 and a second structurable logic arrangement 75.

The third sub-block 7 can calculate source and destination addresses and output them to the other sub-blocks, the μP core, the peripheral units and/or the memory.

The present address in each case is stored in the address register 71 and can be incremented or decremented by the incrementing/decrementing unit 73. The constant register 72 is designed to store an end address, and an address comparison can be carried out by the structurable logic arrangements (in order, for example, to be able to check whether the address stored in the address register 71 has reached the end address stored in the constant register 72).

The provision of this third sub-block 7 is optional and is very useful in particular (but not exclusively) when the SLE layer 12 has direct access to the memory.

In the example considered, the fourth sub-block 8 serves for injecting instructions into the pipeline of the μP core 11; in the example considered, it comprises a constant register 81 and a structurable logic arrangement 82.

Instructions are injected under the control of the second sub-block 6, more precisely the control signals output by the latter. The instruction code of the instruction to be injected is stored in the constant register 81 and is communicated as required (if appropriate together with address and data information) via the structurable logic arrangement 82 to the μP core 11; for this purpose, the second sub-block 6 puts the structurable logic arrangement 82, as required, into a state in which the instruction code stored in the constant register 81 (if appropriate together with the data output from the first sub-block 5 and/or the address output from the third sub-block 7) is injected into the pipeline of the μP core.

As has already been mentioned or indicated at least in part above, there are diverse cross-connections between the individual sub-blocks 5 to 8. The cross-connections depicted in FIG. 4 are to be regarded only as examples. The number of cross-connections and the beginning and end points thereof depend in particular on the concrete application of the relevant logic block and the number and function of the sub-blocks thereof and may be designed, as required, as configurable connections.

The at least partial division of the logic blocks of the logic block unit 122 of the SLE layer 12 into sub-blocks enables the practical realization of the logic blocks with minimal complexity. In particular, considerably fewer linkage possibilities have to be provided compared with the realization of the logic block unit using one or more structurable logic arrangements which can be used universally; the reason for this is that because each sub-block only has to perform one precisely defined task, the sub-blocks in each case have to be able to link only a few signals with one another—in contrast to structurable logic arrangements which can be used universally.

The tasks which have to be performed by the respective sub-blocks, and the cross-connections between the individual sub-blocks make it possible for the relevant logic blocks to have similar performance to that of logic blocks constructed using structurable logic arrangements which can be used universally.

This holds true even when the logic blocks are divided into sub-blocks which are constructed differently and/or have to perform different tasks and/or have different cross-connections and/or are provided in a larger or smaller number than the sub-blocks 5 to 8 which are used in the example considered in the present case and are described with reference to FIG. 4.

In the case of data group operations, it may be necessary to additionally integrate memory units into the SLE layer 12. In that case, results required for later calculations do not have to be swapped into storage devices provided outside the SLE layer 12, but rather can be immediately (buffer-) stored internally within the SLE layer 12.

In the example considered, the structurable logic arrangements used in the sub-blocks are DNF logic arrangements whose construction essentially corresponds to the construction of the DNF logic arrangements used in the clock generation unit 121; in this case, the input and output signals are not, of course, clock signals but rather data and/or control signals, and required clock signals (for example for clocking the flip-flops) are selected from the clock signals generated by the clock generation unit 121.

However, there is no restriction to the effect that the structurable logic arrangements of the logic block 122 are such or similar DNF logic arrangements; instead, it is also possible to use NAND arrays, multiplexer-based variants or other structurable logic arrangements.

The configuration of the configurable elements of the SLE layer, i.e. the configuration of the multiplexers, the configurable connections within the structurable logic arrangements and the registers can essentially be effected like the configuration of the known field-programmable logic arrangements (PLAs, GALs, PLDs, FPGAs etc.).

A first possibility in this respect consists in the (irreversible) production or erasure of connections using so-called fuses or antifuses.

Another possibility consists in carrying out reversible configuration based on data representing the desired configuration, the data being stored in EPROMS, EEPROMS or the like provided inside or outside the program-controlled unit. As a result, the configuration of the program-controlled unit can be changed a limited number of times.

A further possibility consists in carrying out reversible configuration based on data representing the desired configuration, but where the data are stored in a RAM or the like. As a result, the configuration of the program-controlled unit can be changed an unlimited number of times and very rapidly.

The EPROMs, EEPROMS, RAMs or other memories in which the data representing the configuration of the program-controlled unit are stored are preferably designed in such a way that they can be inserted into the memory or I/O area which can be accessed by the μP core 11. The configuration of the SLE layer 12 can then be set as desired by the μP core 11 itself.

If the intention is to preclude the situation where the operation of the program-controlled unit is disturbed by the configuration of the SLE layer 12, provision may be made for allowing the configuration only at predetermined points in time (for example within a predetermined time after the resetting of the program-controlled unit).

Given appropriate configuration of the SLE layer 12, the latter can be assigned specific tasks which, heretofore, could or had to be processed exclusively or to a very great extent by the μP core 11. These tasks include in particular (but not exclusively) the preprocessing, postprocessing, evaluation and/or control of data and/or signals and also the initiation and monitoring of the cooperation of the devices connected via the SLE layer 12.

If the configuration or a reconfiguration of the SLE layer 12 is permitted at any time, then these tasks can even be swapped dynamically into the SLE layer.

Irrespective of this, that is say even when dynamic configuration of the SLE layer 12 is not possible, the loading on the μP core 11 can be considerably relieved by the SLE layer 12. This is explained below using a practical example.

The example relates to analog/digital conversion of data. More precisely, suppose that

an A/D converter (for example the A/D converter 15) having a conversion width of 8 bits is started by a timer (for example by the timer 17),

the result of the A/D conversion is stored together with a 12-bit counting marker,

the result of the A/D conversion is monitored in respect of specific limit values being exceeded and undershot, in which case branching to a specific routine should be effected when the limit values are exceeded or undershot,

and the operation is terminated after 2048 measurements.

An application of this type requires a relatively high complexity in the case of a purely software-based solution. Since a typical A/D converter integrated in a microcontroller does not yield the result spontaneously, that is to say works as a so-called flash converter and has a conversion time in the region of a few microseconds, one of the following paths must be taken in connection with the exact execution of the application specification:

1) The timer triggers an interrupt. The interrupt service routine starts the A/D conversion and is then ended. The A/D converter likewise triggers an interrupt when the conversion is ended. The interrupt service routine that is thereupon executed causes the A/D conversion result to be read out and processed.

2) The timer triggers an interrupt. In the interrupt service routine that is thereupon executed, the A/D conversion is started, there is a wait for the end of the conversion, and finally (after the end of the conversion) the A/D conversion result is read out and processed.

If the conversion times are shorter than the interrupt latency times, the second variant should be preferred. Otherwise, the first variant would be preferable. In general, however, the third variant below is the most favorable:

3) The timer triggers an interrupt. In the interrupt service routine that is thereupon executed, the last A/D conversion result is read out, the next A/D conversion is started, and the A/D conversion result that has been read out is evaluated.

In this third variant, although the A/D conversion result is generally read and evaluated later than would actually be possible, this delay is generally tolerable.

The complexity that has to be implemented for practical realization of the third variant is undoubtedly the least. Nevertheless the processing of the interrupt service routine whose execution is initiated by the timer interrupt lasts at least (i.e. if one instruction is executed per clock cycle and if there are no instances of the limit values being exceeded or undershot by the A/D conversion results, and if there were not interrupt latency times) 30 clock cycles.

If the execution of this application is shifted as far as possible into the SLE layer 12, then it can be carried out considerably faster.

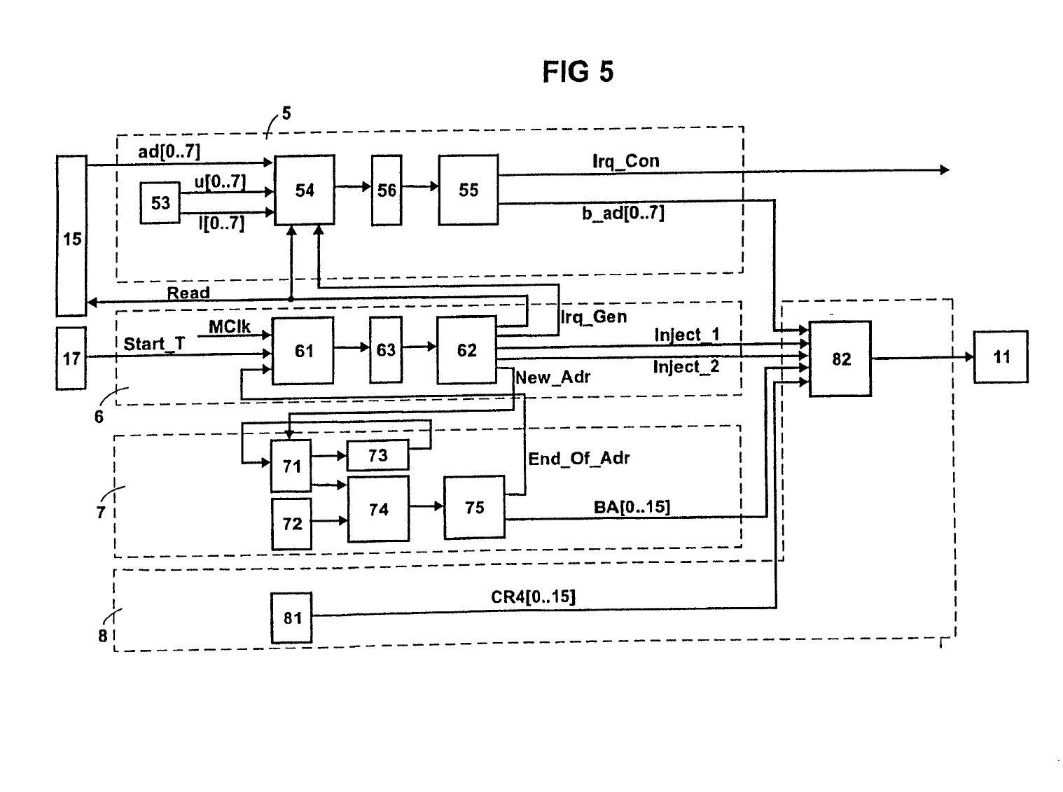

The logic block which is shown in FIG. 4 and described with reference thereto should then be configured, for example, in such a way that the structure shown in FIG. 5 is produced.

The input signals of the arrangement shown in FIG. 5 are the A/D conversion results of the A/D converter 15, which are designated by ad[0 . . . 7], and also the pulses of the timer 17, which are designated by Start_T.

The structurable elements of the logic block in accordance with FIG. 5 are conFig.d in such a way that said logic block, in the event of the limit values being exceeded or undershot by the A/D conversion results and when the end of the measurement series is reached, sends interrupt requests designated by Irq_Con and, for the purpose of storing the A/D conversion results together with the counting marker, injects corresponding instructions into the instruction pipeline of the μP core. In this case, it is incumbent

upon the second sub-block 6 to effect central sequence control within the relevant logic block,

upon the first sub-block 5 to effect comparison of the A/D conversion data ad[0 . . . 7] received from the A/D converter 15 with values u[0 . . . 7] (upper limit value) and 1 [0 . . . 7] (lower limit value) stored in the constant register 53, and to effect generation of the interrupt requests Irq_Con,

upon the third sub-block 7 to effect comparison of addresses (for the purpose of completing the instructions to be injected and for the purpose of determining the end of the measurement series), and

upon the fourth sub-block 8 to effect generation and/or compilation and injection of the instructions to be injected.

In this case, the structurable logic arrangements 61 and 62 are configured in such a way that they generate output signals Irq_Gen, Inject_1, Inject_2, New_Adr and Read on the basis of input signals MClk, Start_T, End_Of_Adr and Reset using internal signals S0, S1, S2 and End_Reached, as defined by the Boolean equations below:

In the structurable logic arrangement 61:

| | |
|---|---|
| S0 = | /S2* /S0 * Start_T * /End_Reached + |
| | /S2 * S1 * /S0 * /End_Reached; |
| S1 = | /S2 * /S1 * S0 * /End_Reached + |
| | /S2 * S1 * /S0 * /End_Reached; |
| S2 = | /S2 * S1 * S0; |

| | |
|---|---|
| S0.CLK = MClk; | /* clocking with MClk */ |
| S1.CLK = MClk; | /* Clocking with MClk */ |
| S2.CLK = MClk; | /* Clocking with MClk */ |

| /* This describes the pass through 5 states, triggered by | |
|---|---|
| Start_T */ | |
| End_Reached = End_Of_Adr + End_Reached * /Reset; | |
| End_Reached.CLK = MClk; | /* Clocking with MClk */ |
| /* Stored End-Flag */ | |

In the structurable logic arrangement 62:

New_Adr = /S2 * S1 * /S0 + /S2 * S1 * S0;
/* Signal for state 2 and 3 */
Inject_1 = /S2 * S1 * /S0;
/* Injection 1. Move instruction */
Inject_2 = /S2 * S1 * S0;
/* Injection 2. Move instruction */
Read = /S2 * /S1 * S0;
/* Triggering of the read operation */
Irq_Gen = End_Reached;
/* Triggering interrupt request at end */

The structurable logic arrangements 54 and 55 are configured in such a way that they generate output signals Irq_Con1, Irq_Con2, b_ad[0 . . . 7] on the basis of input signals ad[0 . . . 7], u[0 . . . 7], 1[0 . . . 7], Read, Irq_Gen using internal signals tmp_upper [0 . . . 3], tmp_lower[0 . . . 3], tmp_eq[0 . . . 3] (for intermediate results), tmp_ad[0 . . . 7] (for buffer-storage after interrogation) and Irq_Tmp1 (for IRQ generation and resetting) as defined by the Boolean equations below:

In the structurable logic arrangement 54:

| | |
|---|---|
| tmp_upper[z] = | /u[2z+1] * ad[2z+1] + |
| | u[2z+1] * ad[2z+1] * /u[2z] * ad[2z] + |
| | u[2z+1] * ad[2z+1] * /u[2z] * ad[2z]; |
| tmp_lower[z] | 1[2z+1] * /ad[2z+1] + |
| | 1[2z+1] * /ad[2z+1] 1[2z] * /ad[2z] |
| | /1[2z+1] * /ad[2z+1] 1[2z] * /ad[2z]; |
| tmp_eq[z]= | u[2z+1] * ad[2z+1] * u[2z] * ad[2z . . . + |
| | u[2z+1] * ad[2z+1] */u[2z] * ad[2z] + |
| | /u[2z+1] * ad[2z+1] * u[2z] * ad[2z . . . + |
| | /u[2z+1] * /ad[2z+1]* /u[2z] * /ad[2z]; |

| /* z runs from 0 to 3, comparison for larger/smaller and | |
|---|---|
| equality */ | |
| tmp_upper[z].CLK = /Read; /* clocking at read-out end */ | |
| tmp_lower[z].CLK = /Read; /* clocking at read-out end */ | |
| tmp_eq[z].CLK = /Read; /* clocking at read-out end */ | |
| tmp_ad[x] = ad[x] | /* x from 0 . . . 7 */ |
| tmp_ad[x].CLK = /Read; | /* clocking at read-out end */ |
| Irq_Tmp1 = 1; | |
| Irq_Tmpl.CLK = Irq_Gen; | /* clocking with Irg_Gen */ |
| Irq_Tmpl.AR = Irq1Reset; | /* reset with IrglReset */ |

/* Generating IRQ for take-up end */

In the structurable logic arrangement 55:

| Irq_Con1 = Irq_Tmpl; | |
|---|---|
| /* IRQ is generated for take-up end. */ | |
| Irq_Con2 = | tmp_upper[3] + tmp_tmp[3] * tmp_upper[2] + |

tmp_eq[3] * tmp_eq[2] * tmp_upper[1] +
tmp_eq[3] + tmp_eq[2] * tmp_eq[1] *

tmp_upper[0] +

/* Overflow */
tmp_lower[3] + tmp_eq[3] * tmp_lower[2] +
tmp_eq[3] * tmp_eq[2] * tmp_lower[1] +
tmp_eq[3] * tmp_eq[2] * tmp_eq[1] *

tmp_lower[0];

/* Underflow */

| | |
|---|---|
| b_ad[y] tmp_ad[y] | /* y runs from 0 . . . 7 */ |

The structurable logic arrangements 74 and 75 are configured in such a way that they generate output signals End_Adr and BA[0 . . . 15] on the basis of input signals A[0 . . . 15], EA[0 . . . 15] using internal signals temp[0 . . . 7] as defined by the Boolean equations below:

In the structural logic arrangement 74:

| | |
|---|---|
| temp[x] = | /A[2x] * /EA[2x] * /A[2x+1] * /EA[2x+1] + |

A[2x] * /EA[2x] * /A[2x+1] * /EA[2x+1] +
A[2x] * /EA[2x] * A[2x+1] * EA[2x+1] +
A[2x] * EA[2x] * A[2x+1] * EA[2x+1];

/* x runs from 0 to 7, comparison for equality */

In the structurable logic arrangement 75:

| | |
|---|---|
| End_Adr = | temp[0] * temp[1] * temp[2] * temp[3] * |
| | temp[4] * temp[5] * temp[6] * temp[7]; |

| /* produces 1 if addresses and comparison address | |
|---|---|
| identical */ | |
| BA[y] = A[y]; | /* y runs from 0 . . . 15 */ |

The structurable logic arrangement 82 is configured in such a way that it generates output signals Inject and MP[0 . . . 31] (assuming 32-bit interface to the μP core) on the basis of input signals Inject_{—}1, Inject_{—}2, BA[0 . . . 15], b_ad[0 . . . 7], and CR4[0 . . . 15] and defined by the Boolean equations below:

| Inject = Inject_1 + Inject_2; | |
|---|---|
| MP[0 . . . 15] = | CR4[0 . . . 15] * Inject_1 + |
| | CR4[0 . . . 15] * Inject_2; |
| /* the 16-bit instruction code stored */ | |
| /* in CR4[0 . . . 15] is communicated */ | |
| MP[16 . . . 23] = | BA[0 . . . 7] * Inject_1 + |
| | b_ad[0 . . . 7] * Inject_2; |
| MP[24 . . . 31] = | BA[8 . . . 15] * Inject_1; |

/* the operand or operands */
/* (16-bit address or 8-bit AD value) */
/* are communicated */

As is apparent from the explanations above, each time A/D conversion data from the A/D converter are read out and processed, the arrangement in accordance with FIG. 5 passes through four states, namely:

1) Reading of the A/D conversion result ad[0 . . . 7] from the A/D converter with automatic restart of the A/D converter.

2) The A/D conversion result is processed, i.e. the A/D conversion result is compared with an upper limit value u[0 . . . 7] stored in the constant memory 53 and a lower limit value 1[0 . . . 7] likewise stored in the constant memory. At the same time, a first move instruction is injected into the pipeline of the μP core.

3) A second move instruction is injected. This instruction comprises a transfer of the A/D conversion result to the address that has been incremented in the meantime. If the A/D conversion result lies outside the range defined by the limit values, an interrupt request is simultaneously triggered.

4) The end of the 2048 conversions is possibly reached. In this case, a flag is set which prevents further reading-out and processing of A/D conversion results. Furthermore, a further interrupt request is triggered for the purpose of signaling the end of the routine.

If it assumed that each state requires precisely one sequence clock signal, then 4 clock signals are required for each instance of reading out and processing A/D conversion data from the A/D converter; the μP core is temporarily burdened by two or three CPU clock cycles through the injected instructions.

With incorporation of the SLE layer 12, the reading and evaluation of A/D conversion results considered in the present case can be carried out in a small fraction of the time which would be necessary if the procedure were as it has been heretofore, that is to say if the complete sequence control and data processing were essentially left exclusively to the μP core 11.

It goes without saying that similar advantages can also be obtained in conjunction with completely different applications from the example described above.

As a result, the program-controlled unit described can be used optimally in each case for a large number of highly varied applications.

I claim:

1. A program-controlled unit, comprising:
an intelligent core configured to process instructions to be executed;
a plurality of units selected from the group consisting of internal peripheral units disposed inside the program-controlled unit, external peripheral units exterior to the program-controlled unit, and one or more memory devices;
a structurable hardware unit selectively forming an application-specifically configurable intelligent interface for respectively connecting said intelligent core and said units, including an interface connection between said intelligent core and said internal peripheral units, between said intelligent core and said external peripheral units, between said intelligent core and said memory devices, and between said plurality of units; and
wherein said structurable hardware unit is configured to evaluate and process data and/or signals received thereby.

2. The program-controlled unit according to claim 1, wherein said structurable hardware unit is disposed in circuit terms between said intelligent core and said plurality of units.

3. The program-controlled unit according to claim 1, wherein said structurable hardware unit is connected to a multiplicity of potential data and signal sources and data and signal destinations, and wherein a plurality of multiplexers are connected to said structurable hardware unit for selecting current data and signal sources and current data and signal destinations.

4. The program-controlled unit according to claim 3, wherein the data and signal sources and the data and signal destinations comprise units selected from the group of units consisting of said intelligent core, said peripheral units, said memory devices, and portions of said structurable hardware unit.

5. The program-controlled unit according to claim 1, wherein a structuring of said structurable hardware unit selectively results in an alteration of given data paths and in a configuration of logic elements.

6. The program-controlled unit according to claim 1, wherein said structurable hardware unit comprises a clock generation unit generating a clock signal and a logic block unit connected to receive the clock signal, said logic block unit enabling devices to be connected via said structurable hardware unit to cooperate as desired.

7. The program-controlled unit according to claim 6, wherein said clock generation unit and said logic block unit each contain configurable elements.

8. The program-controlled unit according to claim 6, wherein said clock generation unit is formed at least in part by a device selected from the group consisting of a DNF logic configuration, a NAND array, a multiplexer-based logic variant, and a structurable logic configuration.

9. The program-controlled unit according to claim 6, wherein the logic block unit is formed at least in part by a device selected from the group consisting of a DNF logic configuration, a NAND array, a multiplexer-based logic variant, and a structurable logic configuration.

10. The program-controlled unit according to claim 6, wherein said logic block unit comprises at least one logic block subdivided at least partly into individually configurable sub-blocks with predetermined tasks.

11. The program-controlled unit according to claim 10, wherein one of said sub-blocks is configured as a processing device enabled for one of arithmetic and logical processing of data input to said sub-block.

12. The program-controlled unit according to claim 10, wherein one of said sub-blocks is configured as a state machine for central sequence control.

13. The program-controlled unit according to claim 10, wherein one of said sub-blocks is configured as an address calculation device for calculating source and destination addresses.

14. The program-controlled unit according to claim 10, wherein one of said sub-blocks is configured as an instruction injection device for injecting instructions into an instruction pipeline of said intelligent core.

15. The program-controlled unit according to claim 1, wherein said structurable hardware unit is configurable with devices selected from the group consisting of fuses and anti-fuses.

16. The program-controlled unit according to claim 1, wherein said structurable hardware unit is reversibly configurable.

17. The program-controlled unit according to claim 16, wherein said structurable hardware unit is configurable based on data representing a desired configuration, and the data are stored in memory devices insertible into a memory or I/O area which is addressible by said intelligent core.

18. The program-controlled unit according to claim 1, wherein a configuration of said structurable hardware unit is enabled only at predetermined times.

19. The program-controlled unit according to claim 1, wherein a configuration of said structurable hardware unit is enabled at any time.

20. A program-controlled unit, comprising:
an intelligent core having an instruction pipeline and processing instructions to be executed;
a plurality of units selected from the group consisting of internal peripheral units disposed inside the program-controlled unit, external peripheral units exterior to the program-controlled unit, and one or more memory devices;
a structurable hardware unit selectively forming an application-specifically configurable intelligent interface for respectively connecting said intelligent core and said units, including an interface connection between said intelligent core and said internal peripheral units, between said intelligent core and said external peripheral units, between said intelligent core and said memory devices, and between said plurality of units; and
wherein said structurable hardware unit is configured to inject instructions into said instruction pipeline of said intelligent core.

21. The program-controlled unit according to claim 20, wherein said structurable hardware unit is disposed in circuit terms between said intelligent core and said plurality of units.

22. The program-controlled unit according to claim 20, wherein said structurable hardware unit is connected to a multiplicity of potential data and signal sources and data and signal destinations, and wherein a plurality of multiplexers are connected to said structurable hardware unit for selecting current data and signal sources and current data and signal destinations.

23. The program-controlled unit according to claim 22, wherein the data and signal sources and the data and signal destinations comprise units selected from the group of units consisting of said intelligent core, said peripheral units, said memory devices, and portions of said structurable hardware unit.

24. The program-controlled unit according to claim 20, wherein a structuring of said structurable hardware unit selectively results in an alteration of given data paths and in a configuration of logic elements.

25. The program-controlled unit according to claim 20, wherein said structurable hardware unit comprises a clock generation unit generating a clock signal and a logic block unit connected to receive the clock signal, said logic block unit enabling devices to be connected via said structurable hardware unit to cooperate as desired.

26. The program-controlled unit according to claim 25, wherein said clock generation unit and said logic block unit each contain configurable elements.

27. The program-controlled unit according to claim 25, wherein said clock generation unit is formed at least in part by a device selected from the group consisting of a DNF logic configuration, a NAND array, a multiplexer-based logic variant, and a structurable logic configuration.

28. The program-controlled unit according to claim 25, wherein the logic block unit is formed at least in part by a device selected from the group consisting of a DNF logic configuration, a NAND array, a multiplexer-based logic variant, and a structurable logic configuration.

29. The program-controlled unit according to claim 25, wherein said logic block unit comprises at least one logic block subdivided at least partly into individually configurable sub-blocks with predetermined tasks.

30. The program-controlled unit according to claim 29, wherein one of said sub-blocks is configured as a processing device enabled for one of arithmetic and logical processing of data input to said sub-block.

31. The program-controlled unit according to claim 29, wherein one of said sub-blocks is configured as a state machine for central sequence control.

32. The program-controlled unit according to claim 29, wherein one of said sub-blocks is configured as an address calculation device for calculating source and destination addresses.

33. The program-controlled unit according to claim 29, wherein one of said sub-blocks is configured as an instruction injection device for injecting instructions into said instruction pipeline of said intelligent core.

34. The program-controlled unit according to claim 20, wherein said structurable hardware unit is configurable with devices selected from the group consisting of fuses and anti- fuses.

35. The program-controlled unit according to claim 20, wherein said structurable hardware unit is reversibly configurable.

36. The program-controlled unit according to claim 35, wherein said structurable hardware unit is configurable based on data representing a desired configuration, and the data are stored in memory devices insertible into a memory or I/O area which is addressible by said intelligent core.

37. The program-controlled unit according to claim 20, wherein a configuration of said structurable hardware unit is enabled only at predetermined times.

38. The program-controlled unit according to claim 20, wherein a configuration of said structurable hardware unit is enabled at any time.

39. A program-controlled unit, comprising:
an intelligent core configured to process instructions to be executed;
a plurality of units selected from the group consisting of internal peripheral units disposed inside the program-controlled unit, external peripheral units exterior to the program-controlled unit, and one or more memory devices;
a structurable hardware unit selectively forming an application-specifically configurable intelligent interface for respectively connecting said intelligent core and said units, including an interface connection between said intelligent core and said internal peripheral units, between said intelligent core and said external peripheral units, between said intelligent core and said memory devices, and between said plurality of units; and
wherein said structurable hardware unit is configured to generate and to output signals selected from the group consisting of interrupt requests and event-signaling messages.

40. The program-controlled unit according to claim 39, wherein said structurable hardware unit is disposed in circuit terms between said intelligent core and said plurality of units.

41. The program-controlled unit according to claim 39, wherein said structurable hardware unit is connected to a multiplicity of potential data and signal sources and data and signal destinations, and wherein a plurality of multiplexers are connected to said structurable hardware unit for selecting current data and signal sources and current data and signal destinations.

42. The program-controlled unit according to claim 41, wherein the data and signal sources and the data and signal destinations comprise units selected from the group of units consisting of said intelligent core, said peripheral units, said memory devices, and portions of said structurable hardware unit.

43. The program-controlled unit according to claim 39, wherein a structuring of said structurable hardware unit selectively results in an alteration of given data paths and in a configuration of logic elements.

44. The program-controlled unit according to claim 39, wherein said structurable hardware unit comprises a clock generation unit generating a clock signal and a logic block unit connected to receive the clock signal, said logic block unit enabling devices to be connected via said structurable hardware unit to cooperate as desired.

45. The program-controlled unit according to claim 44, wherein said clock generation unit and said logic block unit each contain configurable elements.

46. The program-controlled unit according to claim 44, wherein said clock generation unit is formed at least in part by a device selected from the group consisting of a DNF logic configuration, a NAND array, a multiplexer-based logic variant, and a structurable logic configuration.

47. The program-controlled unit according to claim 44, wherein the logic block unit is formed at least in part by a device selected from the group consisting of a DNF logic configuration, a NAND array, a multiplexer-based logic variant, and a structurable logic configuration.

48. The program-controlled unit according to claim 44, wherein said logic block unit comprises at least one logic block subdivided at least partly into individually configurable sub-blocks with predetermined tasks.

49. The program-controlled unit according to claim 48, wherein one of said sub-blocks is configured as a processing device enabled for one of arithmetic and logical processing of data input to said sub-block.

50. The program-controlled unit according to claim 48, wherein one of said sub-blocks is configured as a state machine for central sequence control.

51. The program-controlled unit according to claim 48, wherein one of said sub-blocks is configured as an address calculation device for calculating source and destination addresses.

52. The program-controlled unit according to claim 48, wherein one of said sub-blocks is configured as an instruction injection device for injecting instructions into an instruction pipeline of said intelligent core.

53. The program-controlled unit according to claim 39, wherein said structurable hardware unit is configurable with devices selected from the group consisting of fuses and anti-fuses.

54. The program-controlled unit according to claim 39, wherein said structurable hardware unit is reversibly configurable.

55. The program-controlled unit according to claim 54, wherein said structurable hardware unit is configurable based on data representing a desired configuration, and the data are stored in memory devices insertible into a memory or I/O area which is addressible by said intelligent core.

56. The program-controlled unit according to claim 39, wherein a configuration of said structurable hardware unit is enabled only at predetermined times.

57. The program-controlled unit according to claim 39, wherein a configuration of said structurable hardware unit is enabled at any time.

58. A program-controlled unit, comprising:
an intelligent core configured to process instructions to be executed;
a plurality of units selected from the group consisting of internal peripheral units disposed inside the program-controlled unit, external peripheral units exterior to the program-controlled unit, and one or more memory devices;
a structurable hardware unit selectively forming an application-specifically configurable intelligent interface for respectively connecting said intelligent core and said units, including an interface connection between said intelligent core and said internal peripheral units, between said intelligent core and said external peripheral units, between said intelligent core and said memory devices, and between said plurality of units; and
wherein said structurable hardware unit is configured to selectively react to interrupt requests or other event-signaling messages from devices connected thereto and prevent the interrupt requests or the event-signaling messages from being forwarded.

59. The program-controlled unit according to claim 58, wherein said structurable hardware unit is disposed in circuit terms between said intelligent core and said plurality of units.

60. The program-controlled unit according to claim 58, wherein said structurable hardware unit is connected to a multiplicity of potential data and signal sources and data and signal destinations, and wherein a plurality of multiplexers are connected to said structurable hardware unit for selecting current data and signal sources and current data and signal destinations.

61. The program-controlled unit according to claim 60, wherein the data and signal sources and the data and signal destinations comprise units selected from the group of units consisting of said intelligent core, said peripheral units, said memory devices, and portions of said structurable hardware unit.

62. The program-controlled unit according to claim 58, wherein a structuring of said structurable hardware unit selectively results in an alteration of given data paths and in a configuration of logic elements.

63. The program-controlled unit according to claim 58, wherein said structurable hardware unit comprises a clock generation unit generating a clock signal and a logic block unit connected to receive the clock signal, said logic block unit enabling devices to be connected via said structurable hardware unit to cooperate as desired.

64. The program-controlled unit according to claim 63, wherein said clock generation unit and said logic block unit each contain configurable elements.

65. The program-controlled unit according to claim 63, wherein said clock generation unit is formed at least in part by a device selected from the group consisting of a DNF logic configuration, a NAND array, a multiplexer-based logic variant, and a structurable logic configuration.

66. The program-controlled unit according to claim 63, wherein the logic block unit is formed at least in part by a device selected from the group consisting of a DNF logic configuration, a NAND array, a multiplexer-based logic variant, and a structurable logic configuration.

67. The program-controlled unit according to claim 63, wherein said logic block unit comprises at least one logic block subdivided at least partly into individually configurable sub-blocks with predetermined tasks.

68. The program-controlled unit according to claim 67, wherein one of said sub-blocks is configured as a processing device enabled for one of arithmetic and logical processing of data input to said sub-block.

69. The program-controlled unit according to claim 67, wherein one of said sub-blocks is configured as a state machine for central sequence control.

70. The program-controlled unit according to claim 67, wherein one of said sub-blocks is configured as an address calculation device for calculating source and destination addresses.

71. The program-controlled unit according to claim 67, wherein one of said sub-blocks is configured as an instruction injection device for injecting instructions into an instruction pipeline of said intelligent core.

72. The program-controlled unit according to claim 58, wherein said structurable hardware unit is configurable with devices selected from the group consisting of fuses and anti-fuses.

73. The program-controlled unit according to claim 58, wherein said structurable hardware unit is reversibly configurable.

74. The program-controlled unit according to claim 73, wherein said structurable hardware unit is configurable based on data representing a desired configuration, and the data are stored in memory devices insertible into a memory or I/O area which is addressible by said intelligent core.

75. The program-controlled unit according to claim 58, wherein a configuration of said structurable hardware unit is enabled only at predetermined times.

76. The program-controlled unit according to claim 58, wherein a configuration of said structurable hardware unit is enabled at any time.
